(19) United States
(12) Patent Application Publication
(10) Pub. No.: US 2025/0040581 A1
(43) Pub. Date: Feb. 6, 2025

(54) FLAVOR COMPOSITIONS

(71) Applicant: GIVAUDAN SA, VERNIER (CH)

(72) Inventors: loana Maria UNGUREANU, Cincinnati, OH (US); Philip KRAFT, Holzminden (DE); Yosuke ONUMA, Cincinnati, OH (US)

(21) Appl. No.: 18/718,055

(22) PCT Filed: Nov. 17, 2022
(86) PCT No.: PCT/EP2022/082321

§ 371 Date: Jun. 9, 2024

Related U.S. Application Data
(60) Provisional application No. 63/287,744, filed on Dec. 9, 2021.

(51) Int. Cl. A23L 27/20

(52) U.S. Cl. CPC A23L 27/206; A23L 27/2024

(57) ABSTRACT

A flavor composition comprising a compound according to formula (I)

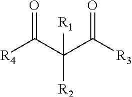

wherein R₁, R₂, R₃, and R₄ independently represent hydrogen or alkyl. A consumable including a flavor composition containing the compound according to formula (I) is also provided. Also provided is a method for imparting, enhancing and/or modifying the buttery, creamy or fatty taste, aroma and/or mouthfeel of a consumable comprising adding to a consumable an organoleptically effective amount of a flavor composition containing the compound according to formula (I).

### TECHNICAL FIELD

The present disclosure relates to flavor compositions and to consumables containing said flavor compositions. The present disclosure further relates to methods for making said flavor compositions and uses of said flavor compositions in consumables, for example to improve the buttery, creamy or fatty taste and/or mouthfeel of consumables.

### BACKGROUND

In the flavor industry, there is a continual demand for compounds and compositions that impart, enhance and/or modify the taste, aroma and/or mouthfeel of a consumable, in particular the buttery, creamy or fatty taste, aroma and/or mouthfeel of a consumable. In particular, it may be desired to replace or reduce reliance on compounds conventionally used to impart, enhance and/or modify buttery taste or aroma such as diacetyl (butane-2,3-dione) and acetyl propionyl (pentane-2,3-dione).

### SUMMARY

It has now been found that compositions comprising certain 2,4-ketones can impart, enhance and/or modify the buttery, creamy or fatty taste, aroma and/or mouthfeel of a consumable. Surprisingly, such compositions are capable of imitating the pleasantly creamy, fatty sensation in the mouth of high-fat consumables in low-fat consumables and at the same time providing a buttery aroma profile.

Disclosed is a flavor composition comprising a compound according to formula (I)

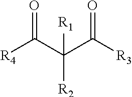

wherein R₁, R₂, R₃, and R₄ independently represent hydrogen or alkyl. In certain embodiments, R₁, R₂, R₃, and R₄ in formula (I) independently represent alkyl. In certain embodiments, R₁, R₂, R₃, and R₄ in formula (I) are independently selected from methyl, ethyl, propyl or butyl. In certain embodiments, R₁, R₂, R₃, and R₄ are independently selected from methyl or ethyl. In certain embodiments, R₁, R₂, R₃, and R₄ are methyl.

Also disclosed are consumables comprising a composition containing the compound according to formula (I).

Also disclosed is a method for imparting, enhancing and/or modifying the buttery, creamy or fatty taste, aroma and/or mouthfeel of a consumable comprising adding to a consumable an organoleptically effective amount of a composition containing the compound according to formula (I).

Also disclosed is a method of imparting a taste, aroma and/or mouthfeel reminiscent of butter to a consumable substantially free of fats or oils, the method comprising the step of incorporating into the consumable a flavor composition comprising a compound according to formula (I).

Also disclosed is the use of a flavor composition comprising a compound according to formula (I) to impart, enhance and/or modify a buttery, creamy or fatty taste, aroma and/or mouthfeel of a consumable.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure relates to a flavor composition comprising a compound according to formula (I)

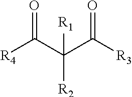

wherein R₁, R₂, R₃, and R₄ independently represent hydrogen or alkyl. In certain embodiments, R₁, R₂, R₃, and R₄ in formula (I) independently represent alkyl. In certain embodiments, R₁, R₂, R₃, and R₄ in formula (I) are independently selected from methyl, ethyl, propyl or butyl. In certain embodiments, R₁, R₂, R₃, and R₄ are independently selected from methyl or ethyl. In certain embodiments, R₁, R₂, R₃, and R₄ are methyl.

In certain embodiments, the compound according to formula (I) has a molecular weight less than 175 g/mol. In certain embodiments, the compound according to formula (I) has a molecular weight less than 170 g/mol. In certain embodiments, the compound according to formula (I) has a molecular weight less than 165 g/mol. In certain embodiments, the compound according to formula (I) has a molecular weight less than 160 g/mol. In certain embodiments, the compound according to formula (I) has a molecular weight less than 155 g/mol. In certain embodiments, the compound according to formula (I) has a molecular weight less than 150 g/mol. In certain embodiments, the compound according to formula (I) has a molecular weight less than 145 g/mol. In certain embodiments, the compound according to formula (I) has a molecular weight less than 140 g/mol. In certain embodiments, the compound according to formula (I) has a molecular weight less than 135 g/mol. In certain embodiments, the compound according to formula (I) has a molecular weight less than 130 g/mol. In certain embodiments, the compound according to formula (I) has a molecular weight of about 125 g/mol to about 175 g/mol. In certain embodiments, the compound according to formula (I) has a molecular weight of about 100 g/mol to about 175 g/mol. In certain embodiments, the compound according to formula (I) has a molecular weight of about 120 g/mol to about 140 g/mol.

In certain embodiments, the compound according to formula (I) is selected from the group consisting of 3,3-Dimethylpentane-2,4-dione, 3-ethenyl-3-methyl-2,4-Pentanedione, 3-ethyl-3-methyl-2,4-Pentanedione, 3,3-diethyl-2,4-Pentanedione, 3,3-dimethyl-2,4-Hexanedione, 3,3-dimethyl-2,4-Heptanedione, 4,4-dimethyl-3,5-Heptanedione, and combinations thereof.

In certain embodiments, the compound according to formula (I) is present in an amount effective to impart, enhance and/or modify a buttery, creamy and/or fatty sensation in the mouth, to intensify the flavor of fats or oil, and/or to imitate the flavor of fats or oils. It has surprisingly been found that the disclosed compositions are capable of imitating the pleasantly creamy, fatty sensation in the mouth of high-fat consumables in low-fat consumables and at the same time providing a buttery aroma profile. In particular, the pleasantly creamy, buttery, fatty sensation in the mouth (usually caused by fats and/or oils) is also perceived to a high degree at a low dosage of the disclosed flavor compositions, even if fats and/or oils are absent or substantially absent.

The flavor of consumables consists of two parts: the aroma and the taste. In general, what is perceived through the olfactory epithelium in the nasal cavity is referred to as ‘aroma’, whereas the term ‘taste’ is generally used to describe the sensory impact that is perceived via the mouth, especially the tongue. The flavor sensation experienced upon consumption, especially taste, provides the final analysis of food prior to ingestion thereof. In certain non-limiting embodiments, the sensory experience of a person exposed to a flavor can be classified as a characteristic experience for the particular flavor. For example, a flavor can be identified by a person as being, but not limited to, a smoky, cheesy, meaty, etc., flavor.

As used herein, the term “taste” is used to describe the sensory response related to taste receptors. The quality of taste may be expressed as the interplay of descriptors. For example, “meaty”, associated with a savoury perception; “body”, associated with combination of perception of heaviness on the tongue, thickness, creaminess and/or fattiness; and “longevity”, associated with time that a full integrated sensory experience sustains itself in the mouth after swallowing. This list of descriptors is not limiting and descriptors may change depending on the application.

Mouthfeel (or “mouth feel”) refers to the physical sensations experienced or felt in the mouth that are created by food and beverages, or compositions added to food or beverages. Mouthfeel may refer to textures that come into contact with the tongue, roof of the mouth, teeth, gums, or throat. Mouthfeel is considered to be distinct from taste/flavour, but is considered to have an equal or even greater impact on a person's enjoyment or preference for certain foods over others. Although not strictly a flavour characteristic, mouthfeel can add—or detract—considerably from a comestible composition. An undesirable mouthfeel can be seriously disadvantageous to an otherwise desirably-flavoured composition. Typical mouthfeel descriptors used to describe perceived sensations include acidity (metallic, citrusy, bright), density (close, airy), dryness (arid, scorched), graininess (particulate, powdery, dusty, grainy, chalky), gumminess (chewy, tough), hardness (crunchy, soft), heaviness (full, weighty), irritation (prickly, stinging), mouth coating (oily, buttery), roughness (abrasive, textured), slipperiness (slimy, stringy), smoothness (satiny, velvety), uniformity (even, uneven) and viscosity (full-bodied, light-bodied).

As stated previously, the perceived mouthfeel of a food or beverage can be broadly influenced by the presence of aroma and taste attributes in addition to textural properties. Thus, a number of other attributes may affect the experienced overall mouthfeel sensation of a product including, for example, one or more of taste or aroma—for example sweet, salty, umami, sour, bitter, creamy sour, acidic, acidic dairy, green onion, toasted onion and parsley.

By “improvement of mouthfeel” it is meant that any one or more of desired mouthfeel perceptions is/are enhanced and/or that any one or more undesirable mouthfeel perceptions is/are reduced. In particular, one or more of the following perceptions may be enhanced by the flavor compositions and methods described herein: buttery, creamy or fatty.

The present disclosure provides formulations, semi-finished goods and odoriferous, aromatic and flavor compositions which comprise the compound according to formula (I) in an organoleptically effective amount. In certain embodiments, the flavor composition comprises a compound according to formula (I) in an amount of about 0.00001% by weight to about 1% by weight, based on the total weight of the flavor composition. In certain embodiments, the flavor composition comprises a compound according to formula (I) in an amount of about 0.00001% by weight to about 0.1% by weight, based on the total weight of the flavor composition. In certain embodiments, the flavor composition comprises a compound according to formula (I) in an amount of about 0.0001% by weight to about 0.005% by weight, based on the total weight of the flavor composition. In certain embodiments, the flavor composition comprises a compound according to formula (I) in an amount of about 0.001% by weight to about 0.004% by weight, based on the total weight of the flavor composition.

In certain embodiments, the flavor composition comprises acetoin. It has been found that the inclusion of acetoin in the disclosed flavor compositions provides a masking effect of unpleasant flavors or off-tastes. In certain embodiments, acetoin is present in an amount of about 40% by weight to about 90% by weight, based on the total weight of the flavor composition. In certain embodiments, acetoin is present in an amount of about 50% by weight to about 80% by weight, based on the total weight of the flavor composition. In certain embodiments, acetoin is present in an amount of about 60% by weight to about 70% by weight, based on the total weight of the flavor composition.

In certain embodiments, the flavor composition comprises one or more of anti-caking agents, anti-foaming agents, antioxidants, binders, colorants, diluents, disintegrants, emulsifiers, encapsulating agents or formulations, enzymes, fats, flavour-enhancers, flavouring agents, gums, lubricants, polysaccharides, preservatives, proteins, solubilizes, solvents, stabilizers, sugar-derivatives, surfactants, sweetening agents, vitamins, waxes, and the like. All of the foregoing are commercially available from Givaudan Flavors Corp. (Cincinnati, Ohio). Solvents which may be used are known to those skilled in the art and include e.g. glycerol, arabitol, erythitol, HSH, isomalt, lactitol, maltitol, mannitol, sorbitol, xylitol, vegetable oils, propylene glycol, ethanol and triacetin. In certain embodiments, the flavor composition comprises propylene glycol in an amount of about 10% by weight to about 99% by weight, based on the total weight of the flavor composition. In certain embodiments, the flavor composition comprises propylene glycol in an amount of about 10% by weight to about 40% by weight, based on the total weight of the flavor composition. In certain embodiments, the flavor composition comprises propylene glycol in an amount of about 20% by weight to about 30% by weight, based on the total weight of the flavor composition.

In certain embodiments, the flavor composition comprises at least one short chain fatty acid. In certain embodiments, the short chain fatty acid comprises butyric acid. Suitable food grade short chain fatty acids are commercially available from Givaudan Flavors Corp. (Cincinnati, Ohio). In certain embodiments, at least one short chain fatty acid is present in an amount of about 1% by weight to about 20% by weight, based on the total weight of the flavor composition. In certain embodiments, at least one short chain fatty acid is present in an amount of about 5% by weight to about 15% by weight, based on the total weight of the flavor composition.

In certain embodiments, the flavor composition comprises at least one of gamma decalactone, delta decalactone, delta dodecalactone, or gamma undecalactone. In certain embodiments, the flavor composition comprises at least two of gamma decalactone, delta decalactone, delta dodecalactone, or gamma undecalactone. In certain embodiments, the flavor composition comprises gamma decalactone, delta decalactone, and delta dodecalactone. These compounds are also commercially available from Givaudan Flavors Corp. (Cincinnati, Ohio). In certain embodiments, at least one of gamma decalactone, delta decalactone, delta dodecalactone, or gamma undecalactone is present in an amount of about 0.1% by weight to about 5% by weight, based on the total weight of the flavor composition. In certain embodiments, at least one of gamma decalactone, delta decalactone, delta dodecalactone, or gamma undecalactone is present in an amount of about 0.5% by weight to about 2% by weight, based on the total weight of the flavor composition.

Examples of additives, excipients, carriers, diluents or solvents that may be included in the disclosed flavor compositions may be found e.g. in “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

In certain embodiments, the flavor composition and/or consumable is free or substantially free of 1,2-diketones. In certain embodiments, the flavor composition is free or substantially free of diketones other than 2,4-diketones. In certain embodiments, the flavor composition is free or substantially free of diacetyl and/or acetyl propionyl. The term “substantially free” means that the flavor composition and/or consumable contains by weight 10% or less, or 5% or less, or 1% or less, or 0% of the stated compound, based on the total weight of the flavor composition or consumable.

Also disclosed are methods of making a flavor composition. In certain embodiments, the flavor composition is prepared by sufficiently mixing a compound of formula (I) with a solvent, and optional additives until a uniform mixture is obtained. In certain embodiments, the flavor composition is prepared by sufficiently mixing a compound of formula (I) with propylene glycol and an off-note blocking compound until a uniform mixture is obtained. In certain embodiments, the flavor composition is prepared by sufficiently mixing a compound of formula (I) with propylene glycol, an off-note blocking compound, and at least one short chain fatty acid until a uniform mixture is obtained. In certain embodiments, the flavor composition is prepared by sufficiently mixing a compound of formula (I) with propylene glycol, an off-note blocking compound, at least one short chain fatty acid, and at least one of gamma decalactone, delta decalactone, delta dodecalactone, or gamma undecalactone until a uniform mixture is obtained. In certain embodiments, the mixture is not subjected to any subsequent processing treatment, such as filtration.

The flavor composition may be in the form of an emulsion, a solution or a powder. For example, it may be desirable or appropriate to add flavor ingredients that are oils, or are oil-soluble to a solution containing all water-soluble ingredients and emulsify the resultant mixture. The composition, in the form of an emulsion could then be further diluted in an aqueous phase, as necessary or appropriate. Alternatively, it may be desirable or appropriate to mix both oil and oil-soluble ingredients, and water-soluble ingredients with a compatible solvent or solvent system, such as propylene glycol, isopropanol, glycerol, ethanol, water, or mixtures thereof to form a composition in the form of a solution or dispersion, which can then be further diluted in an aqueous phase as necessary or appropriate.

In certain embodiments, the flavor composition is present in a powder form that is configured to be reconstituted with water and optionally processed. Depending on the final application, the flavor composition may be in the form of a liquid with or without a solvent or in the form of a solid optionally wherein liquid ingredients are encapsulated or adsorbed on a carrier.

The flavor compositions described herein may be used directly in consumables or may undergo further processing as described above. For example, the flavor compositions may be in filtered and/or concentrated and/or paste and/or spray-dried form. The flavor compositions may, for example, be in combination with a stabilizer, or may be in combination with one or more carriers and/or anti-caking agents used in the spray-drying process. The flavor compositions may, for example, be considered to be an alternative to other compounds conventionally used to impart, enhance and/or modify buttery taste or aroma such as diacetyl and acetyl propionyl for food labelling and/or food regulation reasons.

The flavor compositions may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits.

Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed.

Broadly, consumables include, but are not limited to, foodstuffs of all kinds, confectionery products, baked products, sweet products, savoury products, fermented products, dairy products, beverages, oral care products, nutraceuticals and pharmaceuticals.

Exemplary foodstuffs include, but are not limited to, chilled snacks, sweet and savoury snacks, fruit snacks, chips/crisps, extruded snacks, tortilla/corn chips, popcorn, pretzels, nuts, other sweet and savoury snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, meat analogues, frozen pizza, chilled pizza, soup, canned soup, dehydrated soup, instant soup, chilled soup, UHT soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

Exemplary confectionery products include, but are not limited to, chewing gum (which includes sugarized gum, sugar-free gum, functional gum and bubble gum), centerfill confections, chocolate and other chocolate confectionery, medicated confectionery, lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, combinations of one or more of the above, and edible flavour compositions incorporating one or more of the above.

Exemplary baked products include, but are not limited to, alfajores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savoury biscuits and crackers, bread substitutes.

Exemplary sweet products include, but are not limited to, breakfast cereals, ready-to-eat (“RTE”) cereals, family breakfast cereals, flakes, muesli, other ready to eat cereals, children's breakfast cereals, hot cereals.

Exemplary savoury products include, but are not limited to, salty snacks (potato chips, crisps, nuts, tortilla-tostada, pretzels, cheese snacks, corn snacks, potato-snacks, ready-to-eat popcorn, microwaveable popcorn, pork rinds, nuts, crackers, cracker snacks, breakfast cereals, meats, aspic, cured meats (ham, bacon), luncheon/breakfast meats (hotdogs, cold cuts, sausage), tomato products, margarine, peanut butter, soup (clear, canned, cream, instant, ultrahigh temperature “UHT”), canned vegetables, pasta sauces.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, soy-based desserts.

Exemplary beverages include, but are not limited to, flavoured water, soft drinks, fruit drinks, coffee-based drinks, tea-based drinks, juice-based drinks (includes fruit and vegetable), milk-based drinks, gel drinks, carbonated or non-carbonated drinks, powdered drinks, alcoholic or non-alcoholic drinks, and ready to drink liquid formulations of these beverages.

Exemplary fermented foods include, but are not limited to, cheese and cheese products, meat and meat products, soy and soy products, fish and fish products, grain and grain products, fruit and fruit products.

In certain embodiments, the flavor composition may be added to a consumable in an amount of about 1 ppm to about 100 ppm, based on the total weight of the consumable. In certain embodiments, the flavor composition may be added to a consumable in an amount of about 1 ppm to about 80 ppm, based on the total weight of the consumable. In certain embodiments, the flavor composition may be added to a consumable in an amount of about 1 ppm to about 60 ppm, based on the total weight of the consumable. In certain embodiments, the flavor composition may be added to a consumable in an amount of about 1 ppm to about 50 ppm, based on the total weight of the consumable. In certain embodiments, the flavor composition may be added to a consumable in an amount of about 1 ppm to about 40 ppm, based on the total weight of the consumable. In certain embodiments, the flavor composition may be added to a consumable in an amount of about 3 ppm to about 30 ppm, based on the total weight of the consumable. In certain embodiments, the flavor composition may be added to a consumable in an amount of about 5 ppm to about 25 ppm, based on the total weight of the consumable. In certain embodiments, the flavor composition may be added to a consumable in an amount of about 5 ppm to about 20 ppm, based on the total weight of the consumable. In certain embodiments, the consumable is a beverage, such as a dairy beverage.

Also disclosed is a method for imparting, enhancing and/or modifying a buttery, creamy or fatty taste, aroma and/or mouthfeel of a consumable, wherein the method comprises adding to the consumable an organoleptically effective amount of a compound according to formula (I)

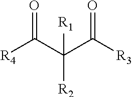

wherein R₁, R₂, R₃, and R₄ independently represent hydrogen or alkyl. In certain embodiments, R₁, R₂, R₃, and R₄ in formula (I) independently represent alkyl. In certain embodiments, R₁, R₂, R₃, and R₄ in formula (I) are independently selected from methyl, ethyl, propyl or butyl. In certain embodiments, R₁, R₂, R₃, and R₄ are independently selected from methyl or ethyl. In certain embodiments, R₁, R₂, R₃, and R₄ are methyl.

In certain embodiments, the compound according to formula (I) has a molecular weight less than 175 g/mol. In certain embodiments, the compound according to formula (I) has a molecular weight less than 170 g/mol. In certain embodiments, the compound according to formula (I) has a molecular weight less than 165 g/mol. In certain embodiments, the compound according to formula (I) has a molecular weight less than 160 g/mol. In certain embodiments, the compound according to formula (I) has a molecular weight less than 155 g/mol. In certain embodiments, the compound according to formula (I) has a molecular weight less than 150 g/mol. In certain embodiments, the compound according to formula (I) has a molecular weight less than 145 g/mol. In certain embodiments, the compound according to formula (I) has a molecular weight less than 140 g/mol. In certain embodiments, the compound according to formula (I) has a molecular weight less than 135 g/mol. In certain embodiments, the compound according to formula (I) has a molecular weight less than 130 g/mol. In certain embodiments, the compound according to formula (I) has a molecular weight of about 125 g/mol to about 175 g/mol.

### Examples

The following examples are given solely for the purpose of illustration and are not to be construed as limitations of the present invention, as many variations of the invention are possible without departing from the spirit and scope of the present disclosure.

A butter flavor composition (without a compound according to formula (I)) was prepared by sufficiently mixing the ingredients shown in Table 1 to provide a substantially uniform distribution.

TABLE 1

| Ingredients | wt. % |
|---|---|
| acetoin | 67.2 |
| propylene glycol | 22 |
| butyric acid | 8.9 |
| gamma decalactone | 0.81 |
| delta decalactone | 0.55 |
| delta dodecalactone | 0.40 |
| ethyl oleate | 0.01 |
| Total | 100 |

Organoleptic evaluation of a 1% milk base containing Samples 1-6 as shown in Table 2 was undertaken by seven (7) sensory trained expert panelists. Samples 4-6 are illustrative flavor compositions of the present disclosure.

TABLE 2

| Sample | Composition | Dose | | Base |
|---|---|---|---|---|
| 1 | diacetyl | 20 | ppm | 1% fat milk |
| 2 | Table 1 composition | 20 | ppm | 1% fat milk |
| 3 | Acetyl propionyl | 4.4 | ppm | 1% fat milk |
| 4 | 3,3-Dimethylpentane-2,4- | 4.4 | ppm | 1% fat milk |
| | dione and propylene glycol | | | |
| 5 | 3,3-Dimethylpentane-2,4- | 8.8 | ppm | 1% fat milk |
| | dione and propylene glycol | | | |
| 6 | 3,3-Dimethylpentane-2,4- | 13.2 | ppm | 1% fat milk |
| | dione and propylene glycol | | | |

The panelists found that:
Sample 1 had a strong buttery flavor and mouthfeel. The organoleptic descriptors used by the panelists were: buttery, very strong even in after taste; mouth coating, heavy, buttery bright; strong buttery aroma; strong upfront impact caramelic.
Sample 2 had a buttery flavor, but less buttery than Sample 1. The organoleptic descriptors used by the panelists were: buttery note; buttery; nice, very pleasant, a slight harsh note; milky, long lasting, heavy cream like.
Sample 3 had a buttery flavor similar to Sample 1. The organoleptic descriptors used by the panelists were: buttery note, blue cheese, green note, stronger impact; butter aroma, much less intense, some butter a little fatty cheesy; slight oxidized butter, grassy, green; nice round, caramelic.
Sample 4 had a less buttery and more creamy flavor than Sample 2. The organoleptic descriptors used by the panelists were: less aroma intensity than Sample 3, cleaner than Sample 3, but suppressed butter character; slight tingle, fatty buttery very slight; sweet round, caramelic; increased mouthfeel.
Sample 5 had a buttery flavor similar to Sample 2. The organoleptic descriptors used by the panelists were: cleaner taste, more milk like than buttery; lactony, mouthfeel, creamy, more butter, more pleasant, less harsh; increased mouthfeel—creamy notes.
Sample 6 had a buttery flavor similar to Samples 4 and 5. The organoleptic descriptors used by the panelists were: some lift on taste, buttery flavor effect at this level; higher astringent, tingle; fatty, butter, creamy, balances well; seems more buttery than Sample 5; close to Sample 3, but more caramelic, less upfront buttery.

The above findings show that the disclosed flavor compositions can be used as an alternative to diacetyl (Sample 1) and acetyl propionyl (Sample 3) in that they provide a similar buttery flavor and mouthfeel but do not have the same potential health concerns as these compounds.

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

It will be understood to one of ordinary skill in the art that the total weight percent of the flavor composition ingredients cannot exceed 100%. A person of ordinary skill in the art would understand that the amount of the components may be adjusted to include the desired amount of components without exceeding 100% by weight of the flavor composition ingredients or the consumable ingredients.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

As used in this specification, the terms “comprises,” “comprising,” “contains,” “containing,” “includes,” “including,” “has,” or “having,” are all open-ended expressions and are intended to cover apparatus, compositions, methods, processes, products, or systems that comprise a recited list of components, elements, and features, and any and all additional components, elements and features that are not expressly recited. The terms “includes,” “including,” “has,” or “having” are not intended to have a more narrow construction, interpretation, or meaning than the terms “comprises” or “comprising.”

As used in the present specification, the term “or” refers to an inclusive “or” and not to an exclusive “or”. For example, the phrase “A or B” is satisfied by any one of the following: A is present and B is not present, A is not present and B is present, and both A and B are present.

As used in the present specification, “a” or “an” is employed to describe components, elements, features and method/process steps of various illustrative embodiments disclosed herein. The use of “a” or “an” should be interpreted to include one or more than one.

As used in the present specification, any of the terms “illustratively,” “preferably,” “commonly,” and “typically” are not intended to, and do not, limit the scope of the claimed embodiments, or to imply that certain features are critical, essential, important, or required to the structure or function of the claimed processes and resulting meat analog products. Rather, these terms are merely intended to identify particular aspects of an embodiment or to emphasize alternative or additional features that may or may not be utilized in a particular embodiment.

What is claimed is:

1. A flavor composition comprising a compound according to formula (I) 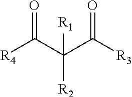
wherein R₁, R₂, R₃, and R₄ independently represent hydrogen or alkyl.

2. The flavor composition according to claim 1, wherein R₁, R₂, R₃, and R₄ independently represent alkyl.

3. The flavor composition according to claim 1, wherein R₁, R₂, R₃, and R₄ are independently selected from methyl, ethyl, propyl or butyl.

4. The flavor composition according to claim 1, wherein R₁, R₂, R₃, and R₄ are independently selected from methyl or ethyl.

5. The flavor composition according to claim 1, wherein the compound according to formula (I) is selected from the group consisting of 3,3-Dimethylpentane-2,4-dione, 3-ethenyl-3-methyl-2,4-Pentanedione, 3-ethyl-3-methyl-2,4-Pentanedione, 3,3-diethyl-2,4-Pentanedione, 3,3-dimethyl-2,4-Hexanedione, 3,3-dimethyl-2,4-Heptanedione, 4,4-dimethyl-3,5-Heptanedione, and combinations thereof.

6. The flavor composition according to claim 1, wherein the compound according to formula (I) has a molecular weight below 175 g/mol.

7. The flavor composition according to claim 1, wherein the compound according to formula (I) is present in an amount effective to impart a buttery sensation in the mouth, to intensify the flavor of fats or oil, or to imitate the flavor of fats or oils.

8. The flavor composition according to claim 1, wherein the compound according to formula (I) is present in an amount of from about 0.00001% by weight to about 0.1% by weight, based on the total weight of the flavor composition.

9. The flavor composition according to claim 8, wherein the compound according to formula (I) is present in an amount of from about 0.0001% by weight to about 0.05% by weight, based on the total weight of the flavor composition.

10. The flavor composition according to claim 8, wherein the compound according to formula (I) is present in an amount of from about 0.001% by weight to about 0.01% by weight, based on the total weight of the flavor composition.

11. The flavor composition according to claim 1, wherein the flavor composition provides a buttery taste, aroma and/or mouthfeel to a consumable.

12. The flavor composition according to claim 1 further comprising acetoin.

13. The flavor composition according to claim 1, wherein the composition is substantially free of 2,3 diketones.

14. The flavor composition according to claim 13, wherein the 2,3-diketones are selected from diacetyl, acetyl propionyl and combinations thereof.

15. A method for imparting, enhancing and/or modifying the buttery taste, aroma and/or mouthfeel of a consumable, said method comprising adding to said consumable an organoleptically effective amount of a compound according to formula (I) 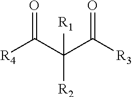
wherein R₁, R₂, R₃, and R₄ independently represent hydrogen or alkyl.
